(19) United States
(12) Patent Application Publication
(10) Pub. No.: US 2011/0161965 A1
(43) Pub. Date: Jun. 30, 2011

(54) JOB ALLOCATION METHOD AND APPARATUS FOR A MULTI-CORE PROCESSOR

(75) Inventors: Dong-Woo IM, Yongin-si (KR); Seung-Mo CHO, Seoul (KR); Seung-Hak LEE, Yongin-si (KR); Oh-Young JANG, Suwon-si (KR); Sung-Jong SEO, Hwaseong-si (KR)

(73) Assignee: SAMSUNG ELECTRONICS CO., LTD., Suwon-si (KR)

(21) Appl. No.: 12/843,320

(22) Filed: Jul. 26, 2010

(30) Foreign Application Priority Data
Dec. 28, 2009 (KR) 10-2009-0131712

(51) Int. Cl. G06F 9/46

(52) U.S. Cl. 718/102

(57) ABSTRACT

A method and apparatus for performing pipeline processing in a computing system having multiple cores, are provided. To pipeline process an application in parallel and in a time-sliced fashion, the application may be divided into two or more stages and executed stage by stage. A multi-core processor including multiple cores may collect correlation information between the stages and allocate additional jobs to the cores based on the collected information.

### CROSS-REFERENCE TO RELATED APPLICATION(S)

This application claims the benefit under 35 U.S.C. §119(a) of Korean Patent Application No. 10-2009-0131712, filed on Dec. 28, 2009, the entire disclosure of which is incorporated herein by reference for all purposes.

### BACKGROUND

1. Field

The following description relates to a multi-core technology, and more particularly, to an apparatus and method for allocating jobs for efficient pipeline processing in a computing system that consists of multiple cores.

2. Description of the Related Art

With the recent increase in demand for low-power, high-performance electronic devices, the need for multi-core processing has increased. Examples of a multi-core processor include a symmetric multi-processing (SMP) system and an asymmetric multi-processing (AMP) system The multi-core processor may consist of various different cores, for example, a digital processing processor (DSP) and a graphic processing unit (GPU), each of which may be used as a general purpose processor (GPP).

To improve performance of software that includes a large amount of data to be processed, the software may be executed using multiple cores in a parallel manner. In this example, the task to be processed is divided into a plurality of jobs (or stages). The jobs include data and each job is allocated to a specified core for data processing. A static scheduling method may be used to process the plurality of jobs. In the static scheduling method the task to be processed is divided into a number of data segments (jobs) equivalent to the number of cores and jobs are allocated to the cores based on the result of the divided data.

In some embodiments, a dynamic scheduling method may be used in which a core that has completed processing an allocated job and then takes over the processing of a part of another job allocated to another core and processes the job to prevent the performance of the cores from deteriorating. The dynamic scheduling method may be used where the job completion timings of the cores are different from one another. The job completion timings may be different due to various influences, for example, influences from an operating system, a multi-core software platform, other application programs, and the like, even when the size of data to be processed is divided equally to each core. The above described methods use individual work queues for the respective cores, and in each of the methods, the entire data is divided into several segments (jobs) and each segment is allocated to the work queue of a specified core at the beginning of a data process.

The static scheduling method may achieve its maximum performance when each core has the same capability and the jobs executed on the cores are not context-switched for another process. The dynamic scheduling method can only be used when a core is able to cancel and take over a job allocated to a work queue of another core. However, because a heterogeneous multi-core platform has cores that have different performances and computing capabilities, it is difficult to estimate an execution time of each core according to a program to be run. Furthermore, because a work queue of each core generally resides in a memory region which only the corresponding core can access, it is not possible for one core to access a work queue of another core in operation to take a job from the work queue.

### SUMMARY

In one general aspect, there is provided a job allocation method of a multi-core processor that includes a plurality of processing cores and which performs pipeline processing of an application in parallel by dividing the application into a plurality of stages and executing the application stage by stage, the method including collecting correlation information between the stages, collecting core capability information with respect to each stage, and designating stages to the plurality of cores based on the correlation information and core capability information.

The correlation information may include a correlation between a first stage and a second stage that has to be executed immediately prior to the first stage according to an execution order of the application.

The correlation information may include a correlation between a stage in a current cycle and the same stage in a previous cycle according to an execution order of the application.

The core capability information with respect to each stage may include information about whether the respective stages can be executed in a corresponding core and the average time elapsed when executing each stage.

The core capability information with respect to each stage may further include at least one of information about whether the execution of a previous stage has to be transmitted to a corresponding core in which a current stage is executed and the time elapsed for transmitting such information, the total time elapsed for executing all stages stored in a work queue of the core, and the average time elapsed for executing each stage stored in the work queue.

The collecting of the core capability information with respect to each stage may occur in each core each time a stage is completed in a respective core.

The multi-core processor may be an asymmetric multi-core system that includes two or more cores with different processing capabilities.

In another aspect, there is provided a computing system including multiple cores, the computing system including one or more job processors each of which includes a core that directly executes one or more stages of a predetermined application and a work queue that stores information of the one or more stages, and a host processor which allocates stages of the predetermined application to the one or more job processors based on correlation information between stages and core capability information with respect to each stage.

The host processor may include a work list management module to manage correlation information between the stages, a core capability management module to periodically manage core capability information with respect to each stage, and a work scheduler to allocate the stages to the job processors based on the correlation information of the work list management module and the core capability information of the core capability management module.

The host processor may further include a work queue monitor to periodically monitor a status of a work queue of each job processor.

The core capability information with respect to each stage may include information about whether the respective stages can be executed in a corresponding core and the average time elapsed when executing each stage.

The core capability information with respect to each stage may further include at least one of information about whether the execution of a previous stage has to be transmitted to a corresponding core in which a current stage is executed and time elapsed for transmitting such information, total time elapsed for executing all stages stored in the work queue of the core, and the average time elapsed for executing each stage stored in the work queue.

The computing system of claim 8, may include two or more cores with different processing capabilities.

In another aspect, there is provided a host processor configured to divide an application to be processed into a plurality of stages, the host processor including a work list management module configured to manage correlation information corresponding to a correlation between the stages of the application, a core capability management module configured to periodically manage core capability information of a plurality of job processing cores, with respect to each stage of the application, and a work scheduler configured to allocate the stages to the plurality of job processing cores based on correlation information and the core capability information.

The host processor may further include a work queue monitor configured to periodically monitor a status of a work queue of each job processor of the plurality of job processors.

Other features and aspects may be apparent from the following detailed description, the drawings, and the claims.

### BRIEF DESCRIPTION OF THE DRAWINGS

FIGS. 1A and 1B are diagrams illustrating examples of pipeline processing an application that is divided into two or more stages.

FIG. 2 is a diagram illustrating an example of a multi-core processor.

FIGS. 3A through 3C are diagrams illustrating examples of pipeline processing based on the capability of each core with respect to each stage in a multi-core processor.

FIGS. 4A and 4B are diagrams illustrating other examples of pipeline processing based on the capability of each core with respect to each stage in a multi-core processor.

FIGS. 5A through 5C are diagrams illustrating other examples of pipeline processing based on the capability of each core with respect to each stage in a multi-core processor.

FIG. 6 is a flowchart illustrating an example of a method for allocating jobs to cores in a multi-core processor.

Throughout the drawings and the description, unless otherwise described, the same drawing reference numerals should be understood to refer to the same elements, features, and structures. The relative size and depiction of these elements may be exaggerated for clarity, illustration, and convenience.

### DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

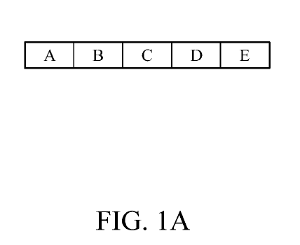

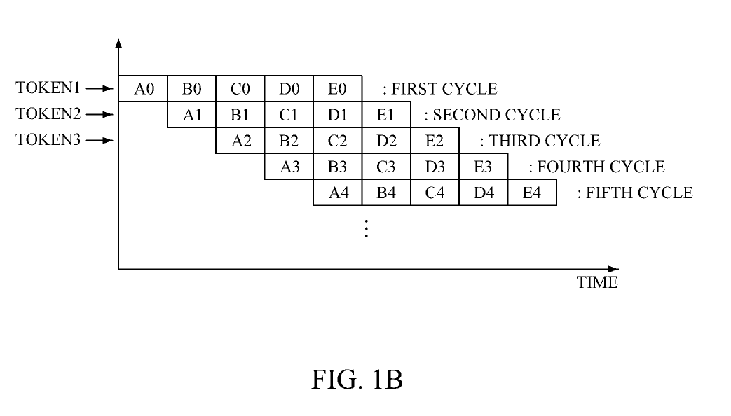

FIGS. 1A to 1B illustrate examples of pipeline-processing an application that is divided is into two or more stages.

Referring to FIG. 1A, the application is composed of five stages to be executed. The five stages are denoted by A, B, C, D, and E, respectively. To run the application each of the five stages is executed. In this example, each stage is subordinate to the preceding stage and the stages are executed in the order of stage A, stage B, stage C, stage D, and stage E. However, it should be appreciated the subordinate scheme is merely for purpose of example. The process of executing each stage in the given order is referred to as a cycle. The data processed during one cycle, which includes the execution of each of stages A through E, is referred to as a token.

FIG. 1B illustrates an example of pipeline processing the application shown in FIG. 1A. In the example shown in FIG. 1B, stage A is represented by stages A0, A1, A2, A3, and A4. Stages B, C, D, and E are similarly represented.

Referring to the example in FIG. 1B, stage A0 of the first cycle is processed by a first core. After stage A0 of the first cycle is executed, stage B0 is executed by the first core and simultaneously stage A1 of a second cycle is executed by a second core. Once a stage BO of the first cycle has been executed, a stage C0 of the first cycle is executed by the first core, and at the same time, stage B1 of the second cycle is executed by the second core and stage A2 of the third cycle is executed by a third core. Accordingly, an application to be processed may be processed in a parallel manner and in time-sliced fashion by dividing the application into two or more stages and executing the application on a stage-by-stage basis.

Referring again to the example shown in FIG. 1B, data that is processed during the first cycle is referred to as a first token, data that is processed during the second cycle is referred to as a second token, and data that is processed during the third cycle is referred to as a third token.

Based on the scheme illustrated in FIG. 1B, a plurality of processing cores may simultaneously process data. Accordingly, as shown in the example of FIG. 1B, five applications may be processed simultaneously by five processing cores.

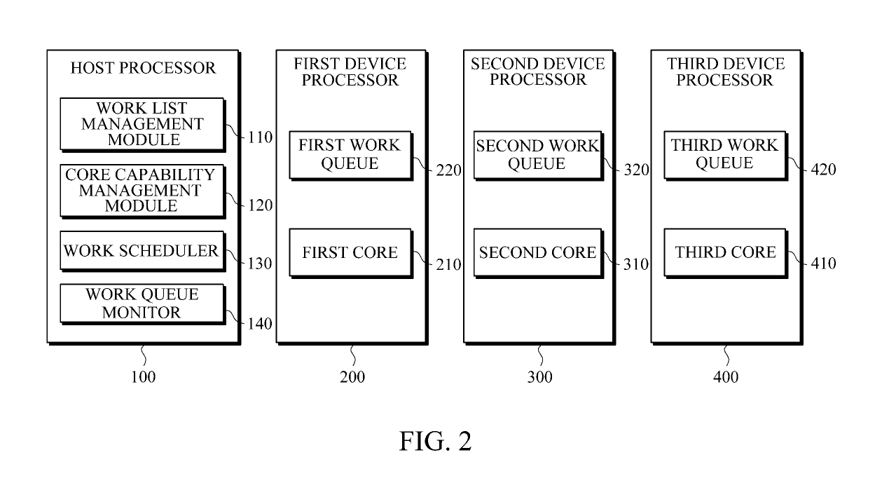

FIG. 2 illustrates an example of a multi-core processor.

Referring to the example shown in FIG. 2, the multi-core processor includes a plurality of processors. The processors include a host processor 100, a first device processor 200, a second device processor 300, and a third device processor 400. The host processor 100 may control and manage stage allocation and stage execution of each device processor 200, 300, and 400. Accordingly, the device processors 200, 300, and 400 may perform pipeline processing of an application in parallel and in time-sliced fashion by dividing the application into two or more stages and executing the application by stages. In this example, the first through third device processors 200, 300, and 400 execute stages allocated to them and under the control of the host processor 100. The multi-core processor may be included in a terminal, such as a mobile terminal, a personal computer (PC), and the like.

The example of a host processor and three job processors shown in FIG. 2 is merely for purposes of example. It should be understood that one or more host processors may be included and a plurality of job processors may be in included in the multi-core processor. For example, the multi-core processor may include two job processors, three job processors, four job processors, or more job processors. In addition, the multi-core processor may include one or more host processors, for example, one host processor, two host processors, or more.

Hereinafter, for convenience of explanation the first, second, and third device processors 200, 300, and 400 are referred to as job processors.

The job processors 200, 300, and 400 include a first core 210, a second core 310, and a third core 410, respectively, and a first work queue 220, a second work queue 320, and a third work queue 420, respectively. Although the multi-core processor shown in the example of FIG. 2 is an asymmetric multi-core processor in which the cores 210, 310, and 410 of the respective job processors 200, 300, and 400 are different from one another, the type of multi-core processor is not limited thereto. Accordingly, two or more of the cores may be of the same type and construction.

The respective first, second, and third work queues 220, 320, and 420, store information of the stages that are to be processed in the corresponding first, second, and third cores 210, 310, and 410. The first, second, and third cores 310, 310, and 410 read data from a storage device based on the information stored in the corresponding first, second, and third work queues. The storage device may be, for example, a primary storage device such as dynamic random access memory (DRAM), a secondary storage device such as hard disk drive, and the like. Subsequently, each of the first, second, and third cores 210, 310, and 410 perform an operation based on the read data.

Each of the first, second, and third cores 210, 310, and 410 may be, for example, a central processing unit (CPU), a digital processing processor (DSP), a graphic processing unit (GPU), and the like. The first through third cores 210, 310, and 410 may be the same processors or they may be different from one another. For example, the first core may be a DSP and the second and third cores 310 and 410 may be GPUs.

The first, second, and third work queues 220, 320, and 420 may be present inside a local memory of the processors 200, 300, and 400, respectively. In addition, the local memory of the processors 200, 300, and 400 may include the first, second, and third cores 210, 310, and 410, respectively.

When pipeline processing an application, the host processor 100 allocates the stages to appropriate job processors 200, 300, and 400 and manages the overall execution of each of the job processors 200, 300, and 400. Accordingly, the host processor 100 may include a work list management module 110, a core capability management module 120, a work scheduler 130, and a work queue monitor 140.

The work list management module 110 may mange correlation information between two or more stages of the application. The correlation information may include information that indicates the relationship between two or more stages. The correlation information between the stages may be determined based on the subordinate relationship between the stages.

The core capability management module 120 may manage capability information indicating the capability of each core. The core capability management module 120 may manage the capability information for a predetermined time interval with respect to the two or more stages of the application. The capability information with respect to each stage may include at least one of whether stages can be executed in the core, the average time elapsed when executing the stage, whether information about the execution of a previous stage has to be transmitted to the core in which a current stage is executed, the time elapsed for transmitting the information, the total time elapsed for executing all the stages stored in the work queue of the core, and the average time elapsed for executing each stage stored in the work queue.

Although each core may initially process every stage with the approximately the same capability, some cores the processing capabilities tend to increase over time due to code transmission time and code cache. Accordingly, in some embodiments only the data that has been executed within a predetermined time by the core may be used to evaluate the core capability, instead of all the data executed by the core. Based on such information, the core capability may be estimated while the number of stages processed by each core and/or the amount of data processed by the core within a predetermined time, may be periodically updated.

The work queue monitor 140 may periodically monitor the work queues 220, 320, and 420 of the respective job processors 200, 300, and 400 included in the multi-core processor. The monitoring intervals of the work queue monitor 140 may vary according to specifications for the performance of the multi-core processor. For example, the cores 210, 310, and 410 may monitor the status of the corresponding work queue 220, 320, and 420 at a predetermined time interval or each time a stage is completed in each of the cores 210, 310, and 410. The work queue monitor 140 may receive notifications from the respective cores 210, 310, and 410, each time a stage is completed.

The work scheduler 130 that operates on the host processor 100 may allocate stages to the job processors 200, 300, and 400 that are capable of pipeline processing an application in parallel and in time-sliced fashion by dividing the application into two or more stages and executing the application stage-by-stage. The work scheduler 130 may determine how many stages will be allocated to each job processor based on the stage correlation information managed by the work list management module 110 and the core capability with respect to each stage which is managed by the core capability management module 120.

The work queue monitor 140 may periodically monitor the status of each of the work queues 220, 320, and 420 of the job processors 200, 300, and 400. The status information of the work queue may include, for example, the number of stages that are stored in the work queue, stage starting time, time elapsed for executing the stage, and the overall or average time elapsed for executing all stages stored in the work queue. The work queue monitor 140 may provide the status information of the work queues 220, 320 and 420 to the work scheduler 130. Accordingly, the work scheduler 130 may refer to the status information when allocating the stages to the job processors 200, 300, and 400.

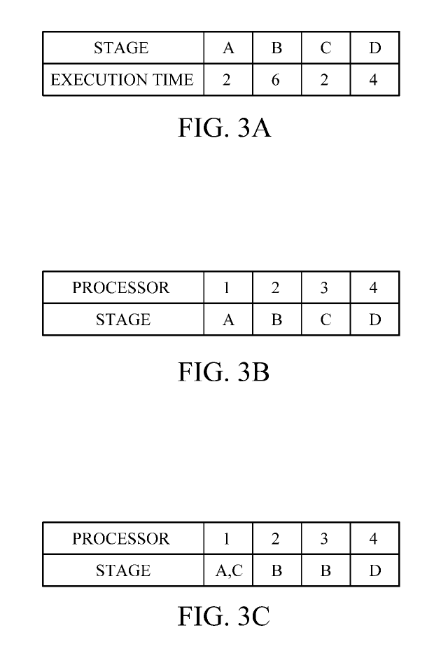

FIGS. 3A through 3C illustrate examples of pipeline processing based on the capability of each core with respect to each stage in a multi-core processor.

In FIGS. 3A through 3C, the multi-core processor is a symmetric multi-core processor (SMP) processor that consists of four identical processors. It should be u understood that the four identical processors are merely for purposes of example, and the processors may be the same, or they may be of a different type and/or kind. An application to be pipeline-processed in pipeline in the multi-core environment shown in FIGS. 3A through 3C comprises four stages including stage A, stage B, stage C, and stage D. FIG. 3A shows the amount of time consumed for processing each stage in the respective processors. FIG. 3B illustrates which core processed which stage shown in FIG. 3A. As shown, the second processor processed stage B and stage B took the longest amount of time to be processed.

The pipeline processing of the above application should process four different stages simultaneously in the fourth cycle using the multi-core processors. If the four stages are allocated to the four processors as shown in FIG. 3B, the overall process speed may be decreased due to a time delay in the second processor.

Accordingly, as shown in FIG. 3C, to overcome the delay caused by the second processor, a first processor may process stage A and stage C, the second and third processors may process stage B, and a fourth processor may process stage D. A host processor may determine which processing core processes which stage based on the core capacity information with respect to each stage and/or the status information of each processing core.

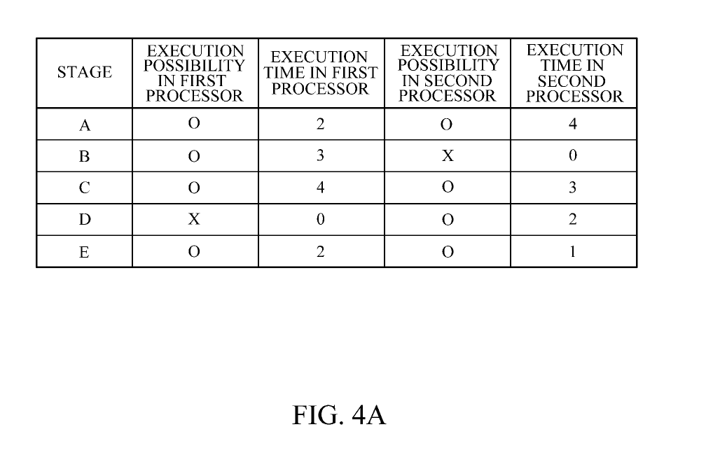

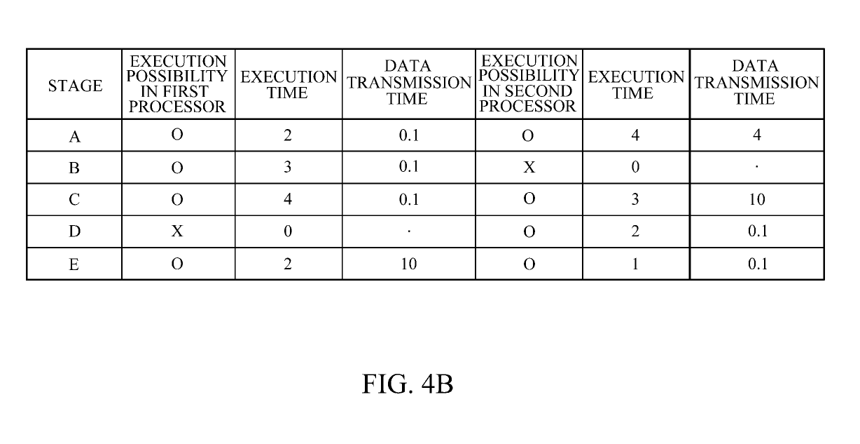

FIGS. 4A and 4B illustrate other examples of pipeline processing based on the capability of each core with respect to each stage in a multi-core processor.

Referring to FIG. 4A, stages A, B, C, and E may be executed in a first processor, and stages A, C, D, and E may be executed in a second processor. Therefore, for example, stages A and B may be executed in the first processor, and then stages C, D, and E may be executed in the second processor in consideration of the time elapsed for executing a stage in each processor.

FIG. 4B illustrates additional times for receiving information from a previous stage to execute a current stage in the respective processors. FIG. 4B also illustrates the times for executing each stage in the respective processors. As shown in the example of FIG. 4B, stage C is executed more quickly in the second processor than in the first processor, but the time for transmitting data generated in stage B from the first processor to the second processor is longer than the time for processing the data in the first processor. Accordingly, stages A, B, and C may be executed in the first processor and stages D and E may be executed in the second processor, based on the amount of time consumed for executing each stage in the respective processor and the amount of time consumed for transmitting data from one processor to another.

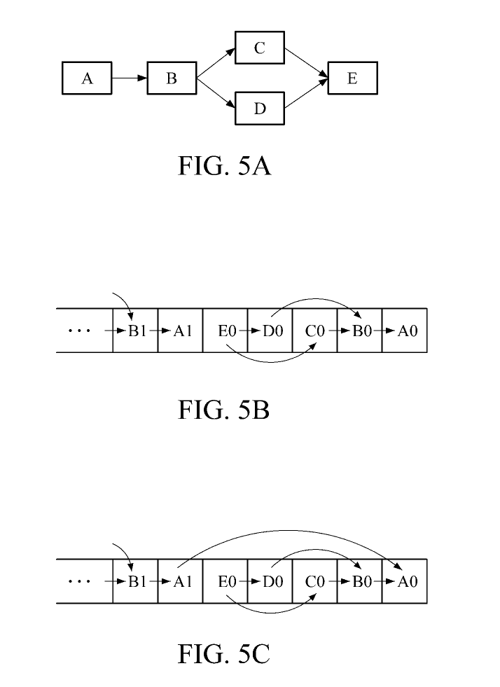

FIGS. 5A through 5C illustrate other examples of pipeline processing based on the capability of each core with respect to each stage in a multi-core processor.

The above-described correlation information may be determined based on the subordinate relationship between stages. Accordingly, a stage subordinate to a preceding stage cannot be executed until the execution of the preceding stage is completed.

FIG. 5A illustrates correlation between stages of an application that are to be executed. Referring to FIG. 5A, the application consists of five stages including stage A, stage B, stage C, stage D, and stage E. When stage B is executed, stage C or D may be selectively executed based on the status of stage B.

FIG. 5B illustrates a subordinate relationship between stages in a work list. The work list includes information of each stage that is to be executed in order to process the application in the multi-core processor. The work list may be stored in an out-of-order queue. Accordingly, the work list may dequeue the recently enqueued stage information first, e.g., a last-in-first-out (LIFO) scheme. This is unlike a first-in-first-out (FIFO) scheme in which the first enqueued stage information is dequeued first.

Referring to FIGS. 5B and 5C, numbers attached to the respective stage identify cycle numbers for pipeline processing of the application, and the stage corresponds to a cycle with the same number. For example, the stage B1 indicates the stage B corresponding to the second cycle (see FIG. 1B).

FIG. 5B illustrates correlation between stages where one stage is subordinate to a stage that has been executed immediately preceding the subordinate stage. For example, stage B0 is subordinate to stage A0, stage C0 and stage D0 are subordinate to stage B0, and stage E0 is subordinate to stage C0 and stage D0. However, in the illustrated example, stage A1 is not is subordinate to stage A0.

Accordingly, while stage A0 is being executed in a first processor, stage B0 cannot be executed in either the first processor or another processor. However, because stage A1 is not subordinate to stage A0, it is possible for stage A1 to be enqueued to a work queue of the first processor or executed in another processor regardless of the execution of stage A0. Again, the illustrated case is for example purposes only.

FIG. 5C illustrates correlation between stages where a stage is subordinate to the same stage in a previous cycle. Although the correlation shown in FIG. 5C is substantially the same as the correlation shown in FIG. 5B, an additional relationship is established between stage A1 and stage A0 because stage A1 is subordinate to stage A0.

Thus, while stage A0 is being executed in the first processor, stage A1 and stage B0 cannot be executed in either the first processor or another processor. After the execution of stage A0 is completed, stage B0 and stage A1 may be executed in the first processor or another processor. The processor in which stage B0 or stage A1 is executed may be determined based on the information of core capability with respect to each stage.

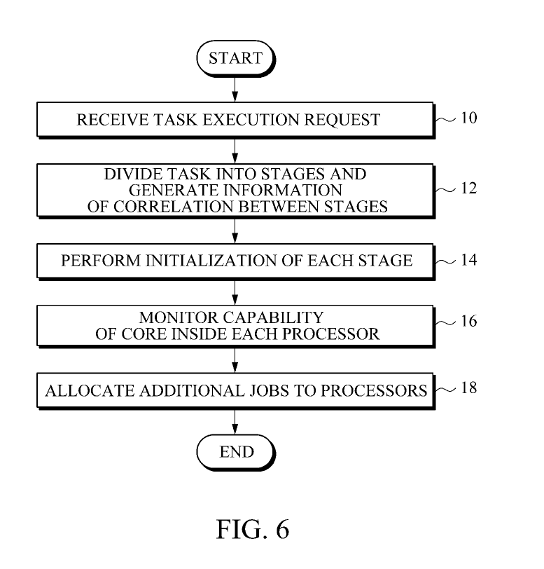

FIG. 6 illustrates an example of a method for allocating jobs to cores in a multi-core processor.

Referring to FIG. 6, the multi-core processor receives a task execution request from a specific application in operation 10. One or more applications may be running on the computing system that includes the multi-core processor. The applications should perform tasks in a fixed order. The tasks include generation of new data and conversion of existing data into data of a different form. Such tasks are performed by the multi-core processor corresponding to a main operating unit which reads in data from a storage device, for example, a primary storage device such as DRAM, a secondary storage device such as hard disk drive, and the like. The multi-core processor processes the data.

In response to the request, in operation 12 the multi-core processor divides the task into stages and generates correlation information between the stages. The stages refer to smaller task units that allow the requested task to be divided up and processed in a pipeline manner. The correlation information may be based on the subordinate relationship between the stages. Accordingly, a subordinate relationship may be established between a first stage and a second stage that is executed prior to the execution of the first stage. That is, the correlation information may refer to the relationship between one stage and a preceding stage. In addition, one stage may have a subordinate relationship with the same stage in the previous cycle, and thus, correlation information may be established between the two stages.

In operation 14, initialization for each stage is performed by the respective processors in the multi-core processor. This procedure is for checking the core capacity of a processing core with respect to each stage. The core capability information with respect to each stage may include at least one of whether stages can be executed in the core, the average time elapsed when executing the stage, whether information about the execution of a previous stage has to be transmitted to the core in which a current stage is executed, the time elapsed for transmitting the information, and the total time elapsed for executing all stages stored in the work queue of the core, and the average time elapsed for executing each stage stored in the work queue.

In one example, the multi-core processor may allocate jobs to processors using the work scheduler that is operated in the host processor. The work scheduler may enqueue information for each stage into the work queue inside each processor.

The multi-core processor periodically monitors the capability of a core inside each processor in operation 16. For example, the multi-core processor may periodically check the status of the work queue of each processor.

An interval for monitoring the work queue may vary with the specifications for the performance of the multi-core processor. For example, the multi-core processor may monitor the status of the work queue in each core at a predetermined time interval or every time a stage is completed in each core. Accordingly, the multi-core processor may receive notifications from the respective cores each time the stage is completed. The notification may include information about the entire time for executing one stage and the job execution starting and termination times.

In one example, the core capability with respect to each stage may include at least one of whether stages can be executed in the core, the average time elapsed when executing the stage, whether information about the execution of a previous stage has to be transmitted to the core in which a current stage is executed, the time elapsed for transmitting the information, the total time elapsed for executing all stages stored in the work queue of the core, and the average time elapsed for executing each stage stored in the work queue.

Although each core may process every stage with the same capability, in some devices capabilities of cores tend to increase over time due to code transmission time and code cache. s Accordingly, only jobs (stages) that have been recently executed by the core may be used to evaluate the core capability, instead of the entire number of jobs executed by the core. Based on such information, the core capability may be estimated while the number of stages processed by each core and/or the amount of data processed by the core within a predetermined time may be periodically updated.

Thereafter, an additional job is allocated to each processor in operation 18. Which stage is allocated to which core may be determined in comprehensive consideration of information of the correlation information between stages that was obtained in operation 10 and information of core capability with respect to each stage that was obtained in operation 14.

Once a unit job allocation for the whole task requested by the application is completed by is repeating operations 14 through 18, the job allocation is terminated and a next instruction is awaited.

The methods described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable lab-top personal computer (PC), a global positioning system (GPS) navigation, and devices such as a desktop PC, a high definition television (HDTV), an optical disc player, a setup box, and the like, capable of wireless communication or network communication consistent with that disclosed herein.

A computing system or a computer may include a microprocessor that is electrically is connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above, and are for nonlimiting example purposes only. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A job allocation method of a multi-core processor comprising a plurality of processing cores and which performs pipeline processing of an application in parallel by dividing the application into a plurality of stages and executing the application stage by stage, the method comprising:
collecting correlation information between the stages;
collecting core capability information with respect to each stage; and
designating stages to the plurality of cores based on the correlation information and core capability information.

2. The method of claim 1, wherein the correlation information comprises a correlation between a first stage and a second stage that has to be executed immediately prior to the first stage according to an execution order of the application.

3. The method of claim 1, wherein the correlation information comprises a correlation between a stage in a current cycle and the same stage in a previous cycle according to an execution order of the application.

4. The method of claim 1, wherein the core capability information with respect to each stage comprises information about whether the respective stages can be executed in a corresponding core and the average time elapsed when executing each stage.

5. The method of claim 4, wherein core capability information with respect to each stage further comprises at least one of information about whether the execution of a previous stage has to be transmitted to a corresponding core in which a current stage is executed and the time elapsed for transmitting such information, the total time elapsed for executing all stages stored in a work queue of the core, and the average time elapsed for executing each stage stored in the work queue.

6. The method of claim 1, wherein the collecting of the core capability information with respect to each stage occurs in each core each time a stage is completed in a respective core.

7. The method of claim 1, wherein the multi-core processor is an asymmetric multi-core system that comprises two or more cores with different processing capabilities.

8. A computing system comprising multiple cores, the computing system comprising:
one or more job processors, each job processor comprising:
a respective core configured to directly execute one or more stages of a predetermined application; and
a work queue configured to store information of the one or more stages; and
a host processor configured to allocate stages of the predetermined application to the one or more job processors based on correlation information between stages and core capability information with respect to each stage.

9. The computing system of claim 8, wherein the host processor comprises:
a work list management module configured to manage correlation information between the stages;
a core capability management module configured to periodically manage core capability information with respect to each stage; and
a work scheduler configured to allocate the stages to the job processors based on the correlation information of the work list management module and the core capability information of the core capability management module.

10. The computing system of claim 9, wherein the host processor further comprises a work queue monitor configured to periodically monitor a status of a work queue of each job processor.

11. The computing system of claim 8, wherein the core capability information with respect to each stage comprises information about whether the respective stages can be executed in a corresponding core and an average time elapsed when executing each stage.

12. The computing system of claim 11, wherein the core capability information with respect to each stage further comprises at least one of: information about whether the execution of a previous stage has to be transmitted to a corresponding core in which a current stage is executed and time elapsed for transmitting such information, total time elapsed for executing all stages stored in the work queue of the core, and the average time elapsed for executing each stage stored in the work queue.

13. The computing system of claim 8, wherein two or more of the cores comprise different processing capabilities.

14. A host processor configured to divide an application to be processed into a plurality of stages, the host processor comprising:
a work list management module configured to manage correlation information corresponding to a correlation between the stages of the application;
a core capability management module configured to periodically manage core capability information of a plurality of job processing cores, with respect to each stage of the application; and
a work scheduler configured to allocate the stages to the plurality of job processing cores based on correlation information and the core capability information.

15. The host processor of claim 14, further comprising a work queue monitor configured to periodically monitor a status of a work queue of each job processor of the plurality of job processors.
